(19) United States
(12) Patent Application Publication
(10) Pub. No.: US 2009/0195512 A1
(43) Pub. Date: Aug. 6, 2009

(54) TOUCH SENSITIVE DISPLAY WITH TACTILE FEEDBACK

(75) Inventor: Helena Elisabet PETTERSSON, Enkoping (SE)

Correspondence Address: HARRITY & HARRITY, LLP, 11350 RANDOM HILLS ROAD, SUITE 600, FAIRFAX, VA, 22030, US

(73) Assignee: SONY ERICSSON MOBILE COMMUNICATIONS AB, Lund (SE)

(21) Appl. No.: 12/026,076

(22) Filed: Feb. 5, 2008

(51) Int. Cl. G06F 3/041

(52) U.S. Cl. 345/173

(57) ABSTRACT

A mobile communication device may include logic configured to receive input on a touch sensitive surface of a device and heat a substance to produce an expansion of the substance in response to the received input, where the expansion of the substance provides tactile feedback to a user indicating that the device has received the input.

### BACKGROUND OF THE INVENTION

Implementations described herein relate generally to input devices, and more particularly, to handheld input devices that may provide tactile feedback.

Devices, such as handheld mobile communication devices, conventionally include input devices that provide some form of tactile feedback to a user indicating that an input has been detected by the communication device. These conventional keypads are formed of physically distinct keys. Currently, there are no adequate solutions of providing tactile feedback to keypads formed of a single physical device or surface, such as a touch sensitive surface.

### SUMMARY OF THE INVENTION

According to one aspect, a mobile communication device is provided. The mobile communication device may comprise a keypad assembly comprising a touch sensitive cover, a paraffin layer, a heating element and a display for displaying information, and logic configured to sense an input on the touch sensitive cover and activate the heating element based on the sensed input to provide tactile feedback to a user.

Additionally, the keypad assembly further comprises an enclosure that contains the paraffin layer and the heating element.

Additionally, the heat provided by the heating element produces an expansion of the paraffin layer to provide the tactile feedback to a user.

Additionally, the logic may be further configured to determine a position of input on the touch sensitive cover and provide tactile feedback to a user in an area on the touch sensitive cover associated with the determined position.

Additionally, the logic may be further configured to output a character to the display based on the determined position of input on the touch sensitive cover.

According to another aspect, a method may be provided. The method may comprise receiving input on a touch sensitive surface of a device and heating a substance to produce an expansion of the substance in response to the received input, where the expansion of the substance provides tactile feedback to a user indicating that the device has received the input.

Additionally, the method may further comprise sensing the input on a touch sensitive surface by a capacitive, resistive or inductive film.

Additionally, the receiving input on a touch sensitive surface comprises detecting a finger of the user on the touch sensitive surface.

Additionally, the method may further comprise determining a position of the received input on the touch sensitive surface and providing tactile feedback in an area on the touch sensitive surface corresponding to the determined position.

Additionally, the method may further comprise displaying a character based on the determined position of the received input on the touch sensitive surface.

According to yet another aspect, a mobile communications device may comprise means for providing a plurality of keypad elements; means for sensing a position of input relative to the plurality of keypad elements; means for providing an expansion of a gel to provide tactile feedback to a user based on the sensed position of input and means for displaying a character based on the sensed position of input relative to the plurality of keypad elements.

Additionally, the means for providing a plurality of keypad elements includes a liquid crystal display (LCD).

Additionally, the means for sensing a position of input relative to the plurality of keypad elements includes a capacitive, inductive, resistive or pressure sensitive film.

Additionally, the means for providing an expansion of a gel to provide tactile feedback to a user based on the sensed position of input includes a heating element.

Additionally, the means for displaying a character based on the sensed position of input relative to the plurality of keypad elements further comprises a liquid crystal display (LCD).

According to yet another aspect, a device may comprise a keypad assembly comprising: a touch sensitive surface and an enclosure that contains a substance and a heating element; and logic configured to: determine an input position on the touch sensitive surface, and activate the heating element to produce an expansion of the substance to provide tactile feedback to a user in response to the determined input position on the touch sensitive surface.

Additionally, the touch sensitive surface is glass.

Additionally, the enclosure is in contact with the bottom of the touch sensitive surface.

Additionally, the substance comprises a paraffin wax or a gel.

Additionally, the enclosure includes a plurality of heating element.

### BRIEF DESCRIPTION OF THE DRAWINGS

The accompanying drawings, which are incorporated in and constitute a part of this specification, illustrate an embodiment of the invention and, together with the description, explain the invention. In the drawings,

FIG. 1 is a diagram of an exemplary implementation of a mobile terminal;

FIG. 2 illustrates an exemplary functional diagram of a mobile terminal;

FIG. 3 illustrates an exemplary functional diagram of the keypad logic of FIG. 2;

FIGS. 4A-4B illustrate an exemplary keypad assembly; and

FIG. 5 is a flowchart of exemplary processing.

### DETAILED DESCRIPTION OF THE INVENTION

The following detailed description of the invention refers to the accompanying drawings. The same reference numbers in different drawings may identify the same or similar elements. Also, the following detailed description does not limit the embodiments.

Exemplary implementations of the embodiments will be described in the context of a mobile communication terminal. It should be understood that a mobile communication terminal is an example of a device that can employ a keypad consistent with the principles of the embodiments and should not be construed as limiting the types or sizes of devices or applications that can use implementations of keypads described herein. For example, keypads consistent with the principles of the embodiments may be used on desktop communication devices, household appliances, such as microwave ovens and/or appliance remote controls, automobile radio faceplates, televisions, video games, computer screens, industrial devices, such as testing equipment, etc.

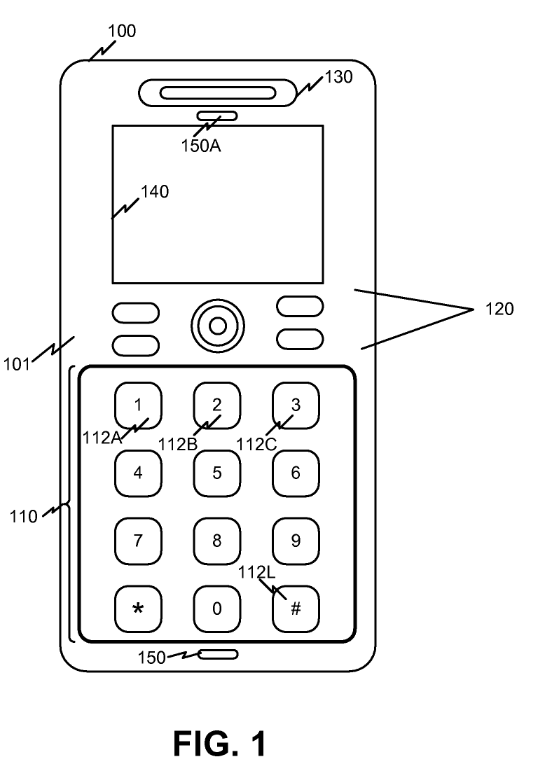

FIG. 1 is a diagram of an exemplary implementation of a mobile terminal consistent with the principles of the embodiments described herein. Mobile terminal 100 (hereinafter terminal 100) may be a mobile communication device. As used herein, a “mobile communication device” and/or “mobile terminal” may include a radiotelephone; a personal communications system (PCS) terminal that may combine a cellular radiotelephone with data processing, a facsimile, and data communications capabilities; a personal digital assistant (PDA) that can include a radiotelephone, pager, Internet/intranet access, web browser, organizer, calendar, and/or global positioning system (GPS) receiver; and a laptop and/or palmtop receiver or other appliance that includes a radiotelephone transceiver.

Terminal 100 may include housing 101, keypad area 110 containing keys 112A-L, control keys 120, speaker 130, display 140, and microphones 150 and 150A. Housing 101 may include a structure configured to hold devices and components used in terminal 100. For example, housing 101 may be formed from plastic, metal, or composite and may be configured to support keypad area 110, control keys 120, speaker 130, display 140 and microphones 150 and/or 150A.

Keypad area 110 may include devices and/or logic that can be used to display images to a user of terminal 100 and to receive user inputs in association with the displayed images. For example, a number of keys 112A-L (collectively referred to as keys 112) may be displayed via keypad area 110. Implementations of keypad area 110 may be configured to receive a user input when the user interacts with keys 112. For example, the user may provide an input to keypad area 110 directly, such as via the user's finger, or via other devices, such as a stylus. User inputs received via keypad area 110 may be processed by components or devices operating in terminal 100.

In one implementation, keypad area 110 may be covered by a single plate of glass, plastic or other material which covers a display that may display characters associated with keys 112. Implementations of keys 112 may have key information associated therewith, such as numbers, letters, symbols, etc. A user may interact with keys 112 to input information into terminal 100. For example, a user may operate keys 112 to enter digits, commands, and/or text, into terminal 100. In one embodiment, character information associated with each of keys 112 may be displayed via a liquid crystal display (LCD).

Control keys 120 may include buttons that permit a user to interact with terminal 100 to cause terminal 100 to perform an action, such as to display a text message via display 140, raise or lower a volume setting for speaker 130, place a telephone call etc.

Speaker 130 may include a device that provides audible information to a user of terminal 100. Speaker 130 may be located in an upper portion of terminal 100 and may function as an ear piece or output device when a user is engaged in a communication session using terminal 100. Speaker 130 may also function as an output device for music and/or audio information associated with games and/or video images played on terminal 100.

Display 140 may include a device that provides visual information to a user. For example, display 140 may provide information regarding information entered via keys 112, incoming or outgoing calls, text messages, games, phone books, the current date/time, volume settings, etc., to a user of terminal 100. Implementations of display 140 may be implemented as black and white or color displays, such as liquid crystal displays (LCDs).

Microphones 150 and/or 150A may, each, include a device that converts speech or other acoustic signals into electrical signals for use by terminal 100. Microphone 150 may be located proximate to a lower side of terminal 100 and may be configured to convert spoken words or phrases into electrical signals for use by terminal 100. Microphone 150A may be located proximate to speaker 130 and may be configured to receive acoustic signals proximate to a user's ear while the user is engaged in a communications session using terminal 100.

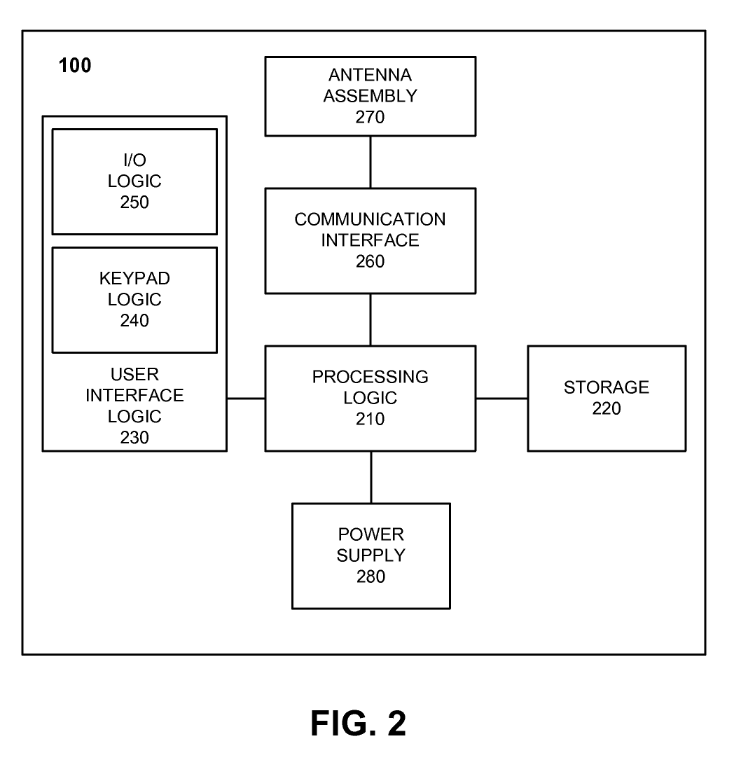

FIG. 2 illustrates an exemplary functional diagram of mobile terminal 100 consistent with the principles described herein. As shown in FIG. 2, terminal 100 may include processing logic 210, storage 220, user interface logic 230, keypad logic 240, input/output (I/O) logic 250, communication interface 260, antenna assembly 270, and power supply 280.

Processing logic 210 may include a processor, microprocessor, an application specific integrated circuit (ASIC), field programmable gate array (FPGA), or the like. Processing logic 210 may include data structures or software programs to control operation of terminal 100 and its components. Implementations of terminal 100 may use an individual processing logic component or multiple processing logic components (e.g., multiple processing logic 210 devices), such as processing logic components operating in parallel. Storage 220 may include a random access memory (RAM), a read only memory (ROM), a magnetic or optical disk and its corresponding drive, and/or another type of memory to store data and instructions that may be used by processing logic 210.

User interface logic 230 may include mechanisms, such as hardware and/or software, for inputting information to terminal 100 and/or for outputting information from terminal 100. In one implementation, user interface logic 230 may include keypad logic 240 and input/output logic 250.

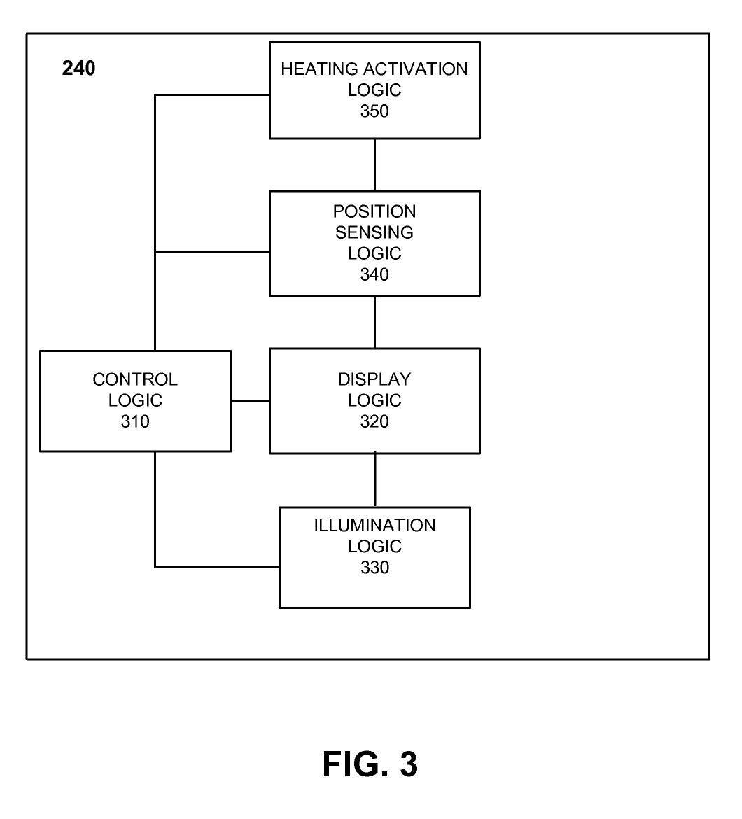

Keypad logic 240 may include mechanisms, such as hardware and/or software, used to control the appearance of keypad area 110 and to receive user inputs via keypad area 110. For example, keypad logic 240 may change displayed information associated with keys 112 using an LCD display. In some implementations, keypad logic 240 may be application controlled and may automatically re-configure the appearance of keypad area 110 based on an application being launched by the user of terminal 100, the execution of a function associated with a particular application/device included in terminal 100 or some other application or function specific event. Keypad logic 240 is described in greater detail below with respect to FIG. 3.

Input/output (I/O) logic 250 may include hardware or software to accept user inputs to make information available to a user of terminal 100. Examples of input and/or output mechanisms associated with input/output logic 250 may include a speaker (e.g., speaker 130) to receive electrical signals and output audio signals, a microphone (e.g., microphone 150 or 150A) to receive audio signals and output electrical signals, buttons (e.g., control keys 120) to permit data and control commands to be input into terminal 100, and/or a display (e.g., display 140) to output visual information.

Communication interface 260 may include, for example, a transmitter that may convert base band signals from processing logic 210 to radio frequency (RF) signals and/or a receiver that may convert RF signals to base band signals. Alternatively, communication interface 260 may include a transceiver to perform functions of both a transmitter and a receiver. Communication interface 260 may connect to antenna assembly 270 for transmission and reception of the RF signals. Antenna assembly 270 may include one or more antennas to transmit and receive RF signals over the air. Antenna assembly 270 may receive RF signals from communication interface 260 and transmit them over the air and receive RF signals over the air and provide them to communication interface 260.

Power supply 280 may include one or more power supplies that provide power to components of terminal 100. For example, power supply 280 may include one or more batteries and/or connections to receive power from other devices, such as an accessory outlet in an automobile, an external battery, or a wall outlet. Power supply 280 may also include metering logic to provide the user and components of terminal 100 with information about battery charge levels, output levels, power faults, etc.

As will be described in detail below, terminal 100, consistent with the principles described herein, may perform certain operations relating to receiving inputs via keypad area 110 in response to user inputs or in response to processing logic 210. Terminal 100 may perform these operations in response to processing logic 210 executing software instructions of a keypad configuration/reprogramming application contained in a computer-readable medium, such as storage 220. A computer-readable medium may be defined as a physical or logical memory device and/or carrier wave.

The software instructions may be read into storage 220 from another computer-readable medium or from another device via communication interface 260. The software instructions contained in storage 220 may cause processing logic 210 to perform processes that will be described later. Alternatively, hardwired circuitry may be used in place of or in combination with software instructions to implement processes consistent with the principles described herein. Thus, implementations consistent with the principles of the embodiments are not limited to any specific combination of hardware circuitry and software.

FIG. 3 illustrates an exemplary functional diagram of the keypad logic 240 of FIG. 2 consistent with the principles of the embodiments. Keypad logic 240 may include control logic 310, display logic 320, illumination logic 330, position sensing logic 340 and heating activation logic 350.

Control logic 310 may include logic that controls the operation of display logic 320 and receives signals from position sensing logic 340. Control logic 310 may determine an input character based on the received signals from position sensing logic 340. Control logic 310 may be implemented as standalone logic or as part of processing logic 210. Moreover, control logic 310 may be implemented in hardware and/or software.

Display logic 320 may include devices and logic to present information via keypad area 110, to a user of terminal 100. Display logic 320 may include processing logic to interpret signals and instructions and a display device having a display area (e.g., keypad area 110) to provide information. Implementations of display logic 320 may include a liquid crystal display (LCD) that includes, for example, biphenyl or another stable liquid crystal material. In this embodiment, keys 112 may be displayed via the LCD.

Illumination logic 330 may include logic to provide backlighting to a lower surface of keypad area 110 in order to display information associated with keys 112. Illumination logic 330 may also provide backlighting to be used with LCD based implementations of display logic 320 to make images brighter and to enhance the contrast of displayed images. Implementations of illumination logic 330 may employ light emitting diodes (LEDs), such as conventional LEDs, organic LEDs (OLEDs), etc., or other types of devices to illuminate portions of a display device. Illumination logic 330 may provide light within a narrow spectrum, such as a particular color, or via a broader spectrum, such as full spectrum lighting. Illumination logic 330 may also be used to provide front lighting to an upper surface of a display device or keypad area 110 that faces a user. Front lighting may enhance the appearance of keypad area 110 or a display device by making information more visible in high ambient lighting environments, such as viewing a display device outdoors.

Position sensing logic 340 may include logic that senses the position and/or presence of an object within keypad area 110. Implementations of position sensing logic 340 may be configured to sense the presence and location of an object. For example, position sensing logic 340 may be configured to determine a location (e.g., a location of one of keys 112) in keypad area 110 where a user places his/her finger, regardless of how much pressure the user exerts on keypad area 110. Implementations of position sensing logic 340 may use capacitive, resistive, inductive or pressure-related techniques to identify the presence of an object and to receive an input via the object. In one implementation for example, position sensing logic 340 may include a transparent film that can be placed within keypad area 110. The film may be adapted to change an output, such as a voltage or current, as a function of a change in capacitance, resistance, inductance or an amount of pressure exerted on the film and/or based on a location where capacitance, resistance, inductance or pressure is exerted on the film. For example, assume that a user presses on the film in an upper left hand corner of the film. The film may produce an output that represents the location at which the pressure was detected. Position sensing logic 340 may also include logic that sends a signal to heating activation logic 350 in response to detecting the position and/or presence of an object within keypad area 110.

Heating activation logic 350 may include mechanisms and logic to provide activation energy to a heating layer, which when activated, produces heat. For example, heating activation logic 350 may receive a signal from position sensing logic 340 and in response to this signal, provide a current and/or voltage to activate a heating layer as described below.

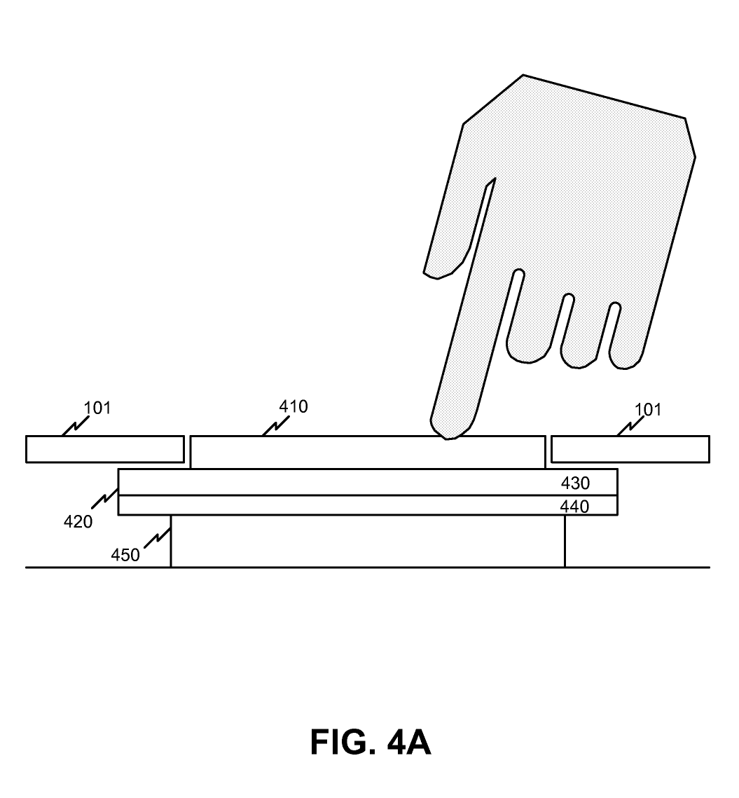

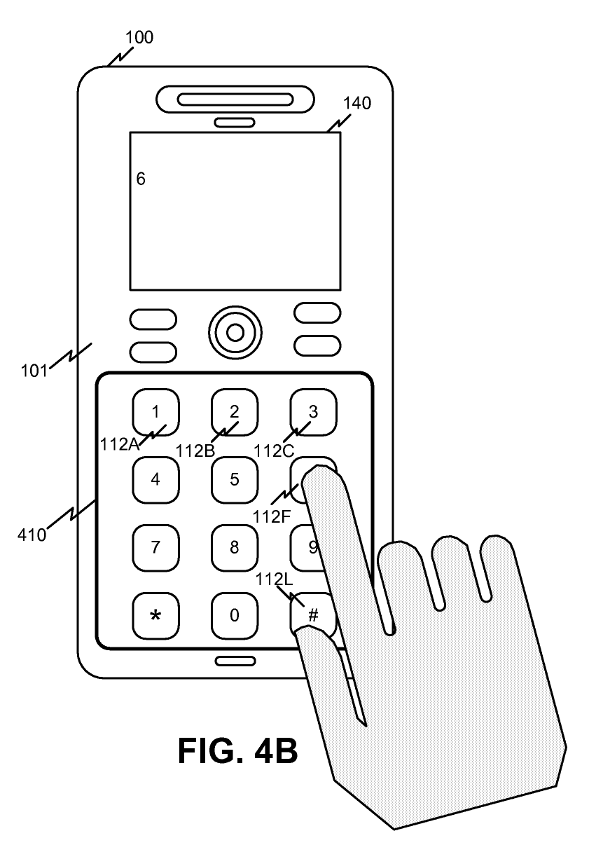

FIGS. 4A and 4B illustrate an exemplary key input system within keypad area 110. As shown, the key input system with keypad area 110 may include housing 101, touch sensitive cover 410, enclosure 420 that contains paraffin layer 430 and heating layer 440 and display screen 450.

As described above, housing 101 may include a hard plastic material used to mount components within terminal 100. In one embodiment, touch sensitive cover 410 may be mounted in housing 101 within keypad area 110.

Touch sensitive cover 410 may include a single sheet of glass that may cover components within keypad area 110. In other embodiments, touch sensitive cover 410 may include other materials, such as plastic or composite material. In each case, touch sensitive cover 410 may include a surface, (e.g., a single surface) located over keypad area 110 and forming part of keypad area 110. As described above, position sensing logic 340 may include a transparent film may be placed on touch sensitive cover 410 or placed underneath touch sensitive cover 410 in order to sense a position of an input (touch).

Enclosure 420 may include an enclosed area for holding or containing paraffin layer 430 and heating layer 440. For example, enclosure 420 may be formed of a clear plastic material. Enclosure 420 may contact the bottom surface of touch sensitive cover 410 so that mechanical vibrations and/or expansions of paraffin layer 430 created within enclosure 420 may be transmitted to touch sensitive cover 410.

Paraffin layer 430 may include a clear layer of paraffin wax, for example. Paraffin layer 430 may have a chemical formula such as CₙH₂ₙ₊₂. Paraffin layer 430 may have expansive properties, such that the volume of paraffin layer 430 may expand or increase when heated. Paraffin layer 430 may be solid at room temperature and may melt when heat is applied. Further, paraffin layer 430 may return to solid form and its original volume when cooled. Paraffin layer 430 may be used to provide a medium in which to create and transmit expansions and/or mechanical vibrations that may be provided or created by applying heat to paraffin layer 430 via a heating layer 440. In other embodiments, paraffin layer 430 may include excess electrons (via electron doping) to form an electrically conductive layer, such that when in contact with heating layer 440, an electrical circuit may be formed as described below.

Heating layer 440 may include a clear layer of electrically conductive material that when activated produces heat. For example, heating layer 440 may include a silicon based material that may receive an electrical signal from heating activation logic 350 and may provide/produce heat in response to the received signal. Heating layer 440 may be included within enclosure 420. When heating layer 440 produces heat, the heat may cause adjacent paraffin layer 430 to melt and expand. The expansion of paraffin layer 430 may be transmitted through enclosure 420 to give the user tactile feedback that a key input has been received by terminal 100. In another exemplary implementation, heating layer 440 may be activated by physically touching paraffin layer 430. For example, when a user presses down on touch sensitive cover 410, an electrical circuit may be formed using an electron doped paraffin layer 430, heating layer 440 and heating activation logic 350. As described above, the current flowing through heating layer 440 may produce heat which causes a volume expansion of paraffin layer 430, which causes a mechanical vibration or other physical sensation to be transmitted through enclosure 420 to provide tactile feedback to a user.

In other exemplary implementations, multiple heating layers 440 and/or multiple discrete heaters may be used and may be located at other positions within terminal 100. For example, there may be multiple heating layers 440 strategically located to provide greater/stronger tactile feedback depending on where the user presses down. For example, keypad area 110 may be divided into four quadrants, where a heating layer 440 may be located in each quadrant. The heating layer 440 located in the quadrant that receives a touch input may be activated in order to provide a stronger expansion of paraffin layer 430 as the expansion/mechanical vibration may be less dispersed. In still other implementations, a heating layer/element may be located below each of keys 112 (or other display elements) in keypad area 110 to provide a stronger tactile feedback.

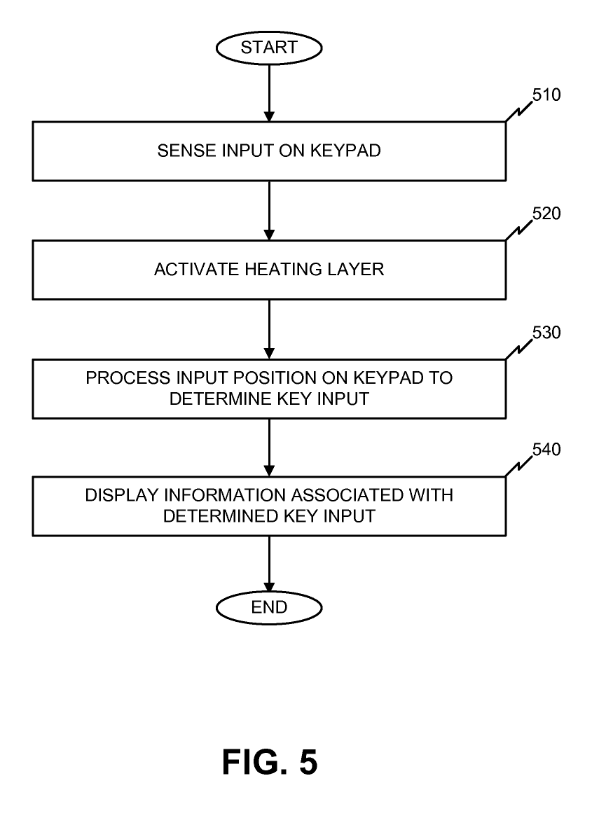

Display screen 450 may include an LCD or similar type of display. Display screen 450 may display characters based on signals received from display logic 320. As shown in FIG. 4B for example, display screen 450 may display keys 112A-112L, which may be seen by a user through touch sensitive cover 410. Operation of the key input system shown in FIGS. 4A-4B is described below with reference to FIG. 5.

FIG. 5 is a flowchart of exemplary processing consistent with the principles described herein. Terminal 100 may provide a keypad configuration as shown in FIG. 1. Process 500 may begin when a position of input may be sensed (block 510). As shown in FIG. 4B for example, a user's finger may be located over (and contacting touch sensitive cover 410) key 112F within keypad area 110. As described above, the position of the user's finger may be sensed by, for example, a capacitive, resistive, inductive or pressure-sensitive film that sends a signal to position sensing logic 340.

While a user's finger is touching one of keys 112 within keypad area 110, heating layer 440 may be activated (block 520). For example, position sensing logic 340 may send a signal to heating activation logic 350 indicating that a user is currently touching one of keys 112 within keypad area 110. In response to this signal, heating activation logic 350 may send a signal and/or provide power to heating layer 440 (block 520). As described above, the signal and/or power (e.g., voltage) applied to heating layer 440 may cause paraffin layer 430 to expand and produce a mechanical vibration or other physical sensation. The mechanical expansion/vibration produced within enclosure 420 may be felt by the user while touching keypad area 110. The mechanical expansion/vibration may provide tactile feedback to the user indicating that terminal 100 has received the input corresponding to the user's intention to enter information associated with one of keys 112. That is, the expansion/vibration within enclosure 420 may be transmitted and sensed at the upper surface of touch sensitive cover 410 to provide tactile feedback to the user. In other examples, heating layer 440 may be activated by forming or completing a closed electrical circuit using an electron doped paraffin layer 430, heating layer 440 and heating activation logic 350 when a user presses down on touch sensitive cover 410 (block 520).

After activating the heating layer 440 and receiving an input signal on keypad area 110, the sensed position signal may be processed to determine a key input (block 530). As shown in FIG. 4B for example, if the position of a user's finger is contacting the “6” key 112F in keypad area 110, position sensing logic 340 may receive signals from a capacitive, resistive, inductive, pressure sensitive film on touch sensitive cover 410. In response to the received signals from the capacitive, resistive, inductive, pressure sensitive film, position sensing logic 340 may determine that the number “6” has been entered by the user.

In response to determining the key input (block 530), the associated information with the determined key input may be displayed (block 540). For example, if position sensing logic 340 determines that key 112F is actuated, a signal may be sent to display logic 320 and control logic 310 in order to display the number “6” via display 140 as illustrated in FIG. 4B. In this manner, a user may be given tactile feedback relating to entered information and also visual feedback.

In further examples, the “2” key (112B) may be associated with the letters “a,” “b” and “c,” in which case, three successive inputs on touch sensitive cover 410 may be sensed while the user's finger is determined to be located on key 112B, in order for position sensing logic 340 to determine that a “c” is the desired character to be entered by a user (block 510). In this example, heating layer 440 may be activated (block 520) after each successive input of the 112B key, in order to provide tactile feedback to the user that each successive key input has been received. That is, the user may receive three separate vibrations/physical indications indicating that the 112B key was pressed three separate times.

It should be understood that although layer 430 has been described as a paraffin layer, it could alternatively include other substances, gels, etc. that expand when heated. Although no particular temperatures associated with the heating were described, such temperatures and other parameters could be determined based on the description/guidance given herein.

### CONCLUSION

Implementations consistent with the principles described herein may provide tactile feedback to a user via a keypad that includes a single surface or cover.

The foregoing description of preferred embodiments of the embodiments provides illustration and description, but is not intended to be exhaustive or to limit the embodiments to the precise form disclosed. Modifications and variations are possible in light of the above teachings or may be acquired from practice of the embodiments.

While a series of acts has been described with regard to FIG. 5, the order of the acts may be modified in other implementations consistent with the principles of the embodiments. Further, non-dependent acts may be performed in parallel.

It will be apparent to one of ordinary skill in the art that aspects of the embodiments, as described above, may be implemented in many different forms of software, firmware, and hardware in the implementations illustrated in the figures. The actual software code or specialized control hardware used to implement aspects consistent with the principles of the embodiments is not limiting of the embodiments. Thus, the operation and behavior of the aspects were described without reference to the specific software code—it being understood that one of ordinary skill in the art would be able to design software and control hardware to implement the aspects based on the description herein.

Further, certain portions of the embodiments may be implemented as “logic” that performs one or more functions. This logic may include hardware, such as hardwired logic, an application specific integrated circuit, a field programmable gate array or a microprocessor, software, or a combination of hardware and software.

It should be emphasized that the term “comprises/comprising” when used in this specification and/or claims is taken to specify the presence of stated features, integers, steps or components but does not preclude the presence or addition of one or more other features, integers, steps, components or groups thereof.

No element, act, or instruction used in the present application should be construed as critical or essential to the embodiments unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A mobile communication device, comprising:
a keypad assembly comprising:
a touch sensitive cover;
a paraffin layer;
a heating element; and
a display for displaying information; and
logic configured to:
sense an input on the touch sensitive cover, and
activate the heating element based on the sensed input to provide tactile feedback to a user.

2. The mobile communication device of claim 1, where the keypad assembly further comprises:
an enclosure that contains the paraffin layer and the heating element.

3. The mobile communication device of claim 2, where heat provided by the heating element produces an expansion of the paraffin layer to provide the tactile feedback to a user.

4. The mobile communication device of claim 1, where the logic is further configured to:
determine a position of input on the touch sensitive cover; and
provide tactile feedback to a user in an area on the touch sensitive cover associated with the determined position.

5. The mobile communication device of claim 4, where the logic is further configured to: output a character to the display based on the determined position of input on the touch sensitive cover.

6. A method, comprising:
receiving input on a touch sensitive surface of a device; and
heating a substance to produce an expansion of the substance in response to the received input, where the expansion of the substance provides tactile feedback to a user indicating that the device has received the input.

7. The method of claim 6, further comprising:
sensing the input on the touch sensitive surface by a capacitive, resistive or inductive film.

8. The method of claim 7, where the receiving input on a touch sensitive surface comprises:
detecting a finger of the user on the touch sensitive surface.

9. The method of claim 6, further comprising:
determining a position of the received input on the touch sensitive surface; and
providing tactile feedback in an area on the touch sensitive surface corresponding to the determined position.

10. The method of claim 9, further comprising:
displaying a character based on the determined position of the received input on the touch sensitive surface.

11. A mobile communication device, comprising:
means for providing a plurality of keypad elements;
means for sensing a position of input relative to the plurality of keypad elements;
means for providing an expansion of a gel to provide tactile feedback to a user based on the sensed position of input; and
means for displaying a character based on the sensed position of input relative to the plurality of keypad elements.

12. The mobile communication device of claim 11, where the means for providing a plurality of keypad elements includes a liquid crystal display (LCD).

13. The mobile communication device of claim 12, where the means for sensing a position of input relative to the plurality of keypad elements includes a capacitive, inductive, resistive or pressure sensitive film.

14. The mobile communication device of claim 13, where the means for providing an expansion of a gel includes a heating element.

15. The mobile communication device of claim 14, where the means for displaying a character based on the sensed position of input relative to the plurality of keypad elements further comprises:
a liquid crystal display (LCD).

16. A device, comprising:
a keypad assembly comprising:
a touch sensitive surface; and
an enclosure that contains a substance and a heating element; and
logic configured to:
determine an input position on the touch sensitive surface, and
activate the heating element to produce an expansion of the substance to provide tactile feedback to a user in response to the determined input position on the touch sensitive surface.

17. The device of claim 16, wherein the touch sensitive surface is glass.

18. The device of claim 17, wherein the enclosure is in contact with the bottom of the touch sensitive surface.

19. The device of claim 18, wherein the substance comprises a paraffin wax or a gel.

20. The device of claim 18, wherein the enclosure includes a plurality of heating elements.
